(19) United States
(12) Patent Application Publication
(10) Pub. No.: US 2019/0118285 A1
(43) Pub. Date: Apr. 25, 2019

(54) WELDING CABLE ASSEMBLIES, WELDING TORCH ASSEMBLIES, AND ROBOTIC WELDING SYSTEMS

(71) Applicant: Illinois Tool Works Inc., Glenview, IL (US)

(72) Inventors: Tiejun Ma, Tecumseh (CA); Romeo Cossette, Amherstburg (CA); Jeffrey Wells, Belle River (CA); Andrew Marchand, Windsor (CA)

(21) Appl. No.: 16/166,852

(22) Filed: Oct. 22, 2018

Related U.S. Application Data
(60) Provisional application No. 62/576,397, filed on Oct. 24, 2017.

(51) Int. Cl. B23K 9/29; B23K 9/133; B23K 37/02

(52) U.S. Cl. CPC B23K 9/29; B23K 9/1336; B23K 9/287; B23K 37/0241; B23K 37/0247; B23K 37/0211

(57) ABSTRACT

Welding cable assemblies, welding torch assemblies, and robotic welding systems are disclosed. An example welding-type cable assembly includes: a cable configured to deliver welding-type current and an electrode wire to a welding-type torch, the cable configured to be coupled to the welding-type torch on a first end and coupled to at least one of a wire feeder or a welding-type power supply on a second end; and a spring mechanically coupled to the cable, the spring having a higher resistance to torque than the cable, and the spring configured to transfer a portion of twisting induced at a first end of the cable past a bend portion of the cable.

### BACKGROUND

This patent claims priority to U.S. Provisional Patent Application Ser. No. 62/576,397, filed Oct. 24, 2017, entitled “WELDING CABLE ASSEMBLIES, WELDING TORCH ASSEMBLIES, AND ROBOTIC WELDING SYSTEMS.” The entirety of U.S. Provisional Patent Application Ser. No. 62/576,397 is incorporated herein by reference.

### BACKGROUND

This disclosure relates generally to robotic welding and, more particularly, to welding cable assemblies, welding torch assemblies, and robotic welding systems.

Robots are used in welding industries. Some welding robots have welding cables routed inside the robot arm, referred to as a through-arm design. The routing of the cable through the robot arm restrict the movement of the cable, and increases the potential for the strain and/or stress concentration in the cable.

### SUMMARY

Robotic welding and, more particularly, to welding cable assemblies, welding torch assemblies, and robotic welding systems are disclosed, substantially as illustrated by and described in connection with at least one of the figures, as set forth more completely in the claims.

### BRIEF DESCRIPTION OF THE DRAWINGS

FIG. 1 illustrates an example robotic welding system, including a robot having a welding torch and a welding cable that travels through an interior of the robotic welding system, in accordance with aspects of this disclosure.

FIG. 2 illustrates a cross-section of the example welding cable of FIG. 1.

FIG. 3 illustrates a cross-section of a cable adapter configured to couple a flexible welding cable to a rigid component of a welding torch body.

FIGS. 4A and 4B illustrate an example weld cable assembly that may be used to implement the welding cable of FIG. 1 with reduced twisting stress, in accordance with aspects of this disclosure.

FIG. 5 is a graph illustrating a comparison of twist lives of a conventional weld cable and the example weld cable assembly of FIGS. 4A and 4B.

FIG. 6A is a block diagram of another example weld cable assembly that may be used to implement the welding cable of FIG. 1 with reduced twisting stress, in accordance with aspects of this disclosure.

FIG. 6B illustrates the example weld cable assembly of FIG. 6A.

FIG. 7 is a block diagram of yet another example weld cable assembly that may be used to implement the welding cable of FIG. 1 with reduced twisting stress, in accordance with aspects of this disclosure.

The figures are not necessarily to scale. Where appropriate, similar or identical reference numbers are used to refer to similar or identical components.

### DETAILED DESCRIPTION

Conventional weld cables are flexible to increase a number of deformation cycles and/or have load carrying reinforcement to make the cable stiffer to have a large bend radius. In through-arm robot applications, the bend radius of the weld cable is limited. Twist strain cannot be transferred across bend portions of weld cables due to the structure and materials of the cable. When the cable is bent and twisted at the same time, the “twist strain” is concentrated at one side of the bending.

Cable assemblies for robotic welding, such as robotic gas metal arc welding (GMAW) torches, are disclosed. Some disclosed weld cable assemblies include a strong spring that is fixed to a torch body at one end and wraps over a weld cable with a tight clearance. The spring is long enough so that when the torch is bent and twisted, the twisting is transferred across a bending portion of the cable, and is distributed more evenly through a long length of the cable. The transfer of the twisting reduces concentration of twisting in the weld cable and improves weld cable life.

As used herein, the term “welding-type current” refers to current suitable for welding, plasma cutting, induction heating, CAC-A and/or hot wire welding/preheating (including laser welding and laser cladding). As used herein, the term “welding-type power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, the term “through-arm robot” refers to a robotic welder in which a weld cable, supplying weld power, shielding gas, and/or consumable electrode, traverses through an interior of at least a portion of the robotic arm between a) a torch body held by the robot and b) a wire feeder or a welding power supply.

As used herein, a “bend portion” of a weld cable refers to a portion of the weld cable that experiences the significant portion of bending induced in the weld cable due to manipulation of an attached weld torch, where the bend portion of the weld cable substantially prevents transfer of twisting stress in the cable from one side of the bend portion along a length of the cable through the bend portion to the other side of the bend portion.

As used herein, the terms “front” and “back” of a robotic welding system refer to direction with respect to a welding current. The “front” element refers to one of multiple elements that are closer to a workpiece or contact tip of a welding torch held by the robot than a corresponding “back” element. For example, a front end of a weld cable refers to the end of the weld cable that is closer to the weld torch, and a back end of the weld cable refers to the end of the weld cable that is farther from the weld torch.

Disclosed example welding-type cable assemblies include: a cable to deliver welding-type current and an electrode wire to a welding-type torch, in which the cable is configured to be coupled to the welding-type torch on a first end and coupled to at least one of a wire feeder or a welding-type power supply on a second end. The example welding-type cable assemblies further include a spring mechanically coupled to the cable and having a higher resistance to torque than the cable, in which spring is configured to reduce transfer a portion of twisting induced at a first end of the cable past a bend portion of the cable.

In some example assemblies, a front end of the spring is rigidly fixed to an external jacket of the cable. In some such examples, a back end of the spring is rigidly fixed to the external jacket of the cable. In some examples, a back end of the spring is rigidly fixed to an external jacket of the cable and a front end of the spring is configured to be rigidly fixed to the welding-type torch. Some such examples further include a power connector attached to the cable, in which a back end of the spring is rigidly fixed to the power connector and the cable is coupled to at least one of the wire feeder or the welding-type power supply via the power connector. In some examples, a back end of the spring is rigidly fixed to the cable at an intermediate location along a length of the cable.

In some example welding-type cable assemblies, the spring and the cable are frictionally coupled along a length of the spring, in which the spring reduces twisting in the cable based on the frictional coupling. In some such examples, the spring distributes twisting stress over a length of the cable that is frictionally coupled to the spring.

In some examples, the welding-type cable assembly is positioned within a robotic arm of a robotic welding system. In some examples, an inner diameter of the spring is between 0.000 inches and 0.100 inches greater than an outer diameter of the cable or the outer diameter of the cable is between 0.000 inches and 0.010 inches greater than the inner diameter of the spring. In some example assemblies, the spring is fixed to the welding-type torch and to a location along a length of the cable, and the spring does not apply a substantial frictional force to the cable in response to torque applied to the spring.

Disclosed example welding-type torch assemblies for a robotic welding systems include a welding-type torch, a cable, and a spring mechanically coupled to the cable. The cable delivers welding-type current and an electrode wire to the welding-type torch, in which the cable is coupled to the welding-type torch on a first end and coupled to at least one of a wire feeder or a welding-type power supply on a second end. The spring has a higher resistance to torque than the cable, and transfers a portion of twisting induced at a first end of the cable past a bend portion of the cable.

In some example welding-type torch assemblies, the spring and the cable are frictionally coupled along a length of the spring, in which the spring reduces concentration of twisting in the cable based on the frictional coupling. In some examples, the spring distributes twisting stress over a length of the cable that is frictionally coupled to the spring.

Some example welding-type torch assemblies further include a power connector attached to the cable, in which a second end of the spring is rigidly fixed to the power connector, and the cable is coupled to at least one of the wire feeder or the welding-type power supply via the power connector.

In some example welding-type torch assemblies, a first end of the spring is rigidly fixed to an external jacket of the cable. In some such examples, a second end of the spring is rigidly fixed to the welding-type torch. In some example welding-type torch assemblies, the spring is fixed to the welding-type torch and to a location along a length of the cable, and the spring does not apply a substantial frictional force to the cable in response to torque applied to the spring.

Disclosed example robotic welding assemblies for robotic welding systems include a welding-type torch; a cable configured to deliver welding-type current and an electrode wire to the welding-type torch, in which the cable is coupled to the welding-type torch on a first end and coupled to at least one of a wire feeder or a welding-type power supply on a second end; a spring mechanically coupled to the cable, the spring having a higher resistance to torque than the cable; and a robotic arm configured to manipulate the welding-type torch, in which the robotic arm bends a portion of the cable when manipulating the welding-type torch, and the spring transfers at least a portion of a twisting stress on a first portion of the cable, resulting from manipulation of the welding-type torch by the robotic arm, to a second portion of the cable across a bend portion of the cable from the first portion of the cable. In some such examples, the cable is disposed within the robotic arm in a through-arm configuration.

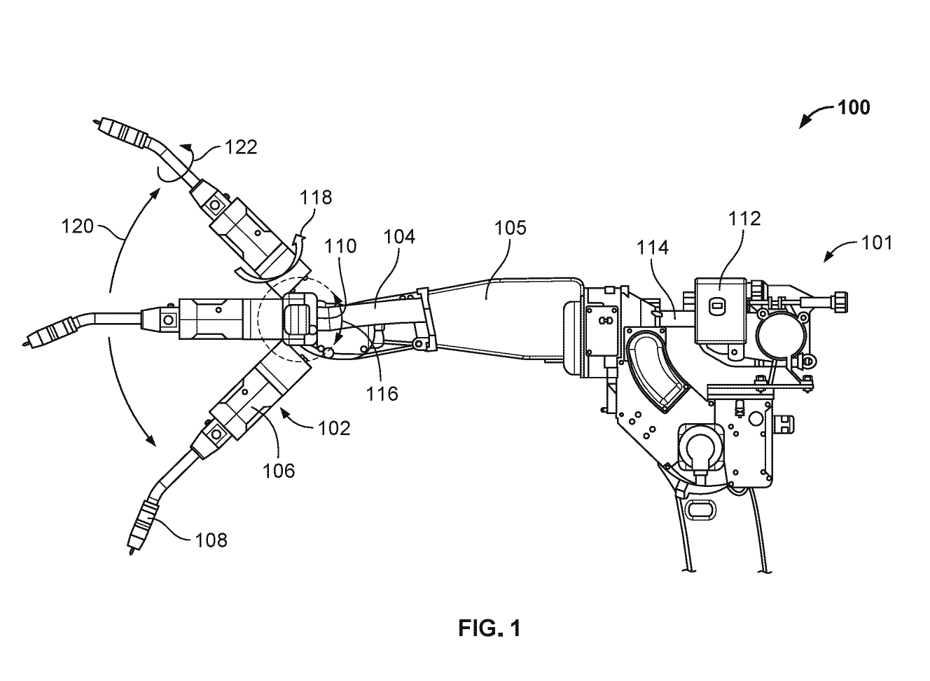

FIG. 1 illustrates an example robotic welding system 100. The robotic welding system 100 includes a robot 101 having a welding torch 102 and a welding cable 104 that travels through an interior of a robot arm 105 of the robot 101.

The torch 102 includes a torch body 106 and front components 108. The example robot 101 manipulates the front components 108 via the torch body 106 to position the torch 102 for welding operations. FIG. 1 illustrates the example torch 102 in multiple positions resulting from manipulation by the robot 101.

The welding cable 104 is connected to the torch body 106 at a first end 110, and is connected to a wire feeder 112 through a power pin 114. The welding cable 104 delivers wire electrode, welding power, and/or welding gas to the torch 102.

The robot 101 may manipulate the torch 102 in multiple degrees of freedom. Two particular movements by the robot 101 affect the contour (e.g., stress and/or strain) of the weld cable 104. A joint 5 (J5) 116 that applies bending 120 to the torch 102, and a joint 6 (J6) 118 applies twist to the torch 102. An example bending limit 120 for the J5 joint 116 is +/−140 degrees. An example twist limit 122 for the J6 joint 118 is +/−360 degrees. Movements of other joints in the robot 101 change the absolute position of the torch 102 but do not change the contour of the weld cable 104.

In some examples, the robot 101 includes a weld cable assembly to implement the weld cable 104 (e.g., to deliver weld power, consumable electrode, and/or weld gas), where the weld cable assembly configured to reduce twist concentration in the cable and/or twisting stress in the cable. In some examples, a spring is rigidly fixed to an external jacket of the weld cable on one or both ends of the spring. The spring may extend the length of the weld cable or part of the length of the weld cable. Examples of such a weld cable assembly are described in more detail below.

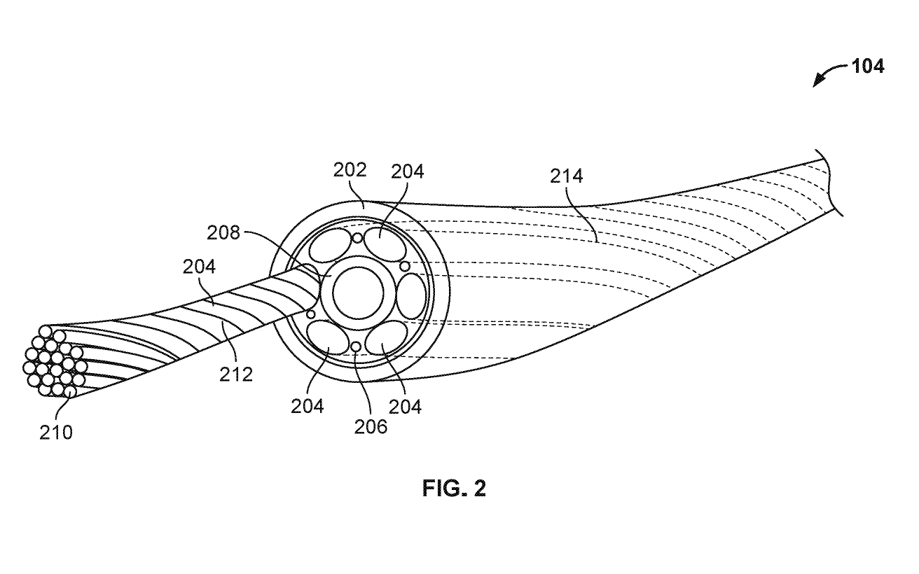

FIG. 2 illustrates a cross-section of the example weld cable 104 of FIG. 1. The weld cable 104 includes a jacket 202, a weld conductor 204, one or more control leads 206, and core tube 208. The jacket 202 may be made of rubber or another material. The weld conductor 204 may be, for example, a bundle 210 of copper wires. The copper wires are coiled in a first helix 212 in the bundle 210, and multiple bundles 210 are coiled in a second helix 214 over the length of the cable 104. The structure of the weld cable 104 increases the flexibility and/or ease of deformation of the weld cable 104 in tangential directions. As a result, twisting of the weld cable 104 (e.g., of the jacket 202, of the weld conductor 204) does not transfer across bends in the weld cable (e.g., when the robot 101 deforms the weld cable 104 by manipulating the torch 102).

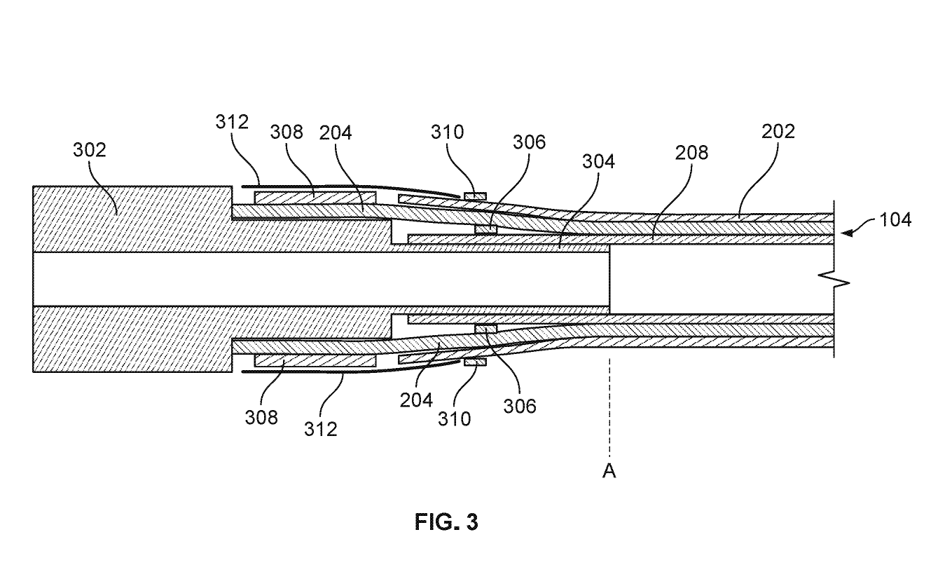

FIG. 3 illustrates a cross-section of a cable adapter 302 configured to couple a flexible weld cable (e.g., the weld cable 104) to a rigid component of a welding torch body (e.g., the torch body 106 of FIG. 1) and/or a power pin (e.g., the power pin 114 of FIG. 1). As illustrated in FIG. 3, the core tube 208 of the cable 104 is pushed over a barbed end 304 of the adapter 302, and crimped by a crimping ring 306. The weld conductors 204 are crimped to the adapter 302 with a copper tube 308. The jacket 202 of the weld cable 104 is also crimped with a crimp 310. Electric tape 312 and/or another electrically insulating attachment device adds insulation and/or adds further structure integrity to the connection between the cable adapter 302 and the weld cable 104.

While the control leads 206 are not shown in FIG. 3, the control leads 206 may either be crimped with the weld conductor 204, or cut short and left inside the jacket 202.

When a bending force is applied to the weld cable 104 (e.g., in a manual welding situation in which an operator holds the torch body in hand and lets the rest of the weld cable 104 lay towards the ground), a stress or strain concentration is created near the region “A” illustrated in FIG. 3. To reduce this concentration, conventional weld torches typically have external strain relief.

For through-arm robots, twisting has a larger adverse effect than bending on the life of the weld cable 104. The length of the weld cable 104 may be substantially shorter than the lengths of weld cables for conventional robots in which the weld cable is routed on an exterior of the robot (e.g., 3-4 feet vs. 6-8 feet). While through-arm robots make similar welds and movement as conventional robots, the strain per unit length of the weld cable is higher in through-arm robots than in conventional robots. Furthermore, the contour of the weld cable 104 is restricted by the robot arm 105. The design of the robot 101, especially the J5 joints 116 and the J6 joint 118, restricts the bending radius that can be achieved by the weld cable 104. When the weld cable 104 is both bent and twisted, the twisting strain is concentrated between the front end and the bending region of the weld cable 104, and the twisting strain is not transferred along the bending region of the weld cable 104. The twisting may cause significant damage to the copper strings inside the cable and, eventually, may cause the weld cable 104 to fail.

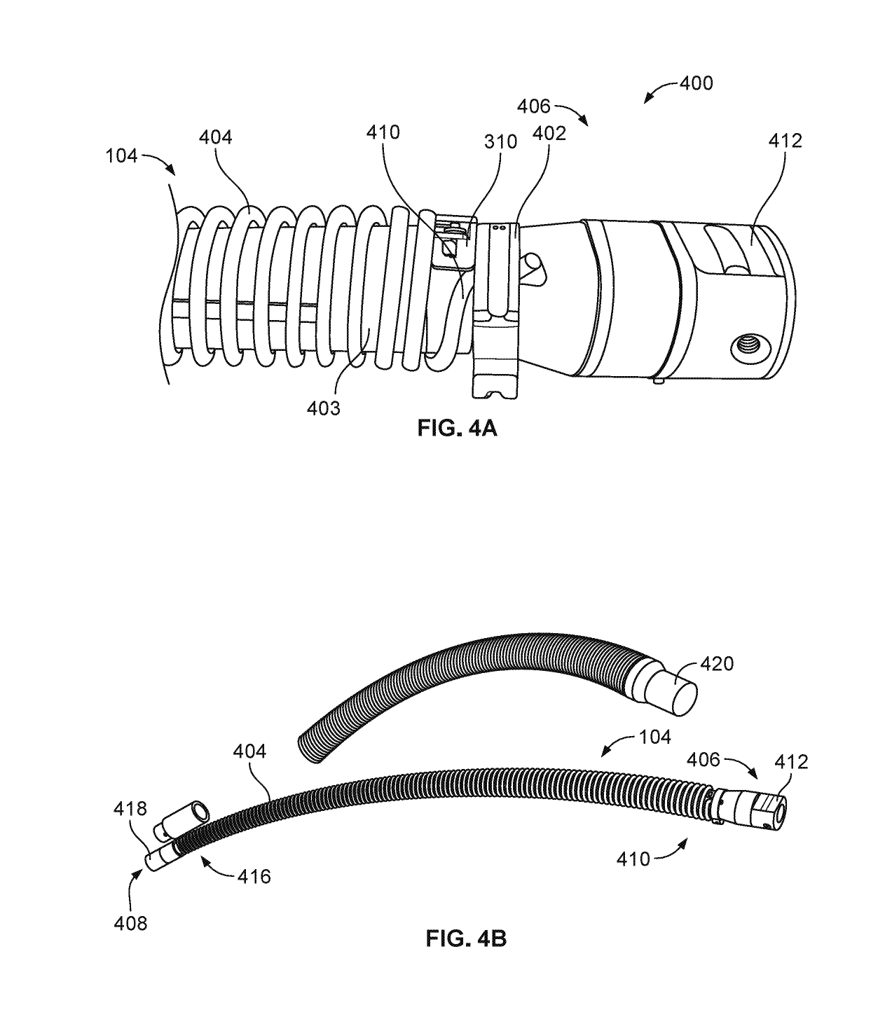

FIGS. 4A and 4B illustrate an example weld cable assembly 400 that may be used to implement the weld cable 104 of FIG. 1 with reduced twisting stress. The example weld cable assembly 400 includes a clamp 402, a cable 403 and a spring 404.

The cable 403 delivers welding current, shielding gas, and electrode wire to a welding torch, such as the weld torch 102 of FIG. 1. The cable 403 is coupled to the weld torch on a first end 406 and coupled to a wire feeder or a welding-type power supply on the other end 408.

The spring 404 is mechanically coupled to the cable 403 through the clamp 402. The spring 404 has a higher resistance to torque (e.g., twisting stress) than the cable 403, and reduces twisting in the cable 403 by reducing concentration of twisting in the cable 403. For example, the spring 404 may disperse twisting in the cable 403 along a longer length of the cable 403 than would be achieved by the cable 403 alone.

In the example of FIG. 4A, a front end 410 of the spring 404 is mechanically connected to a connector 412 on the first end 406 of the cable 403. The connector 412 may be similar or identical to the cable adapter 302 of FIG. 3. The cable 403 is rigidly fixed to the connector 412 (e.g., via the crimp 310) and/or to an external jacket of the cable 403. The connection between the front end 410 and the connector 412 is mechanically rigid and may be connected directly or indirectly. For example, the example front end 410 is crimped to the connector 412 by the clamp 402, so the spring 404 is mechanically fixed to the first end 406 of the cable 403 via the connection with the connector 412.

In the example of FIG. 4B, a back end 416 of the spring 404 is also connected to a second connector 418 of the cable 403, and/or to the external jacket of the cable, opposite the first connector 412. The example second connector 418 may be connected to a power pin of a wire feeder or a welding power supply and may be similar or identical to the connector 412. In the example of FIG. 4B, the back end 416 of the spring 404 is rigidly coupled to the cable 403 in a similar manner as the front end 410 of the spring 404 is connected is to the cable 403. However, other rigid connection techniques may be used.

The inner diameter of the spring 404 is sized to fit the outer diameter of the cable 403. In some examples, the inner diameter of the spring 404 is between 0.000 inches and 0.100 inches greater than an outer diameter of the cable 403. In some examples, the inner diameter of the spring 404 is between 0.000 inches and 0.030 inches greater than an outer diameter of the cable 403. In some examples, the outer diameter of the cable 403 is between 0.000 inches and 0.010 inches greater than the inner diameter of the spring 404.

In some examples, the cable assembly 400 includes a protection hose 420 on an exterior of the spring 404. The protection hose 420 may be plastic or another material and reduces or prevents wear against the interior of the robot arm 105 by the spring 404. The front end protection hose 420 may be fixed to the connector 412. Alternatively, the front end 410 of the spring 404 can be fixed to a corresponding end of the plastic hose 420, and the spring 404 and the hose 420 may be fixed together to the connector 412. In some examples, the spring 404 is electrically insulated from the connectors 412, 418.

When the example cable assembly 400 is used in a through-arm robot such as the robot 101 of FIG. 1, the cable assembly 400 has a substantially longer operating life due to the reduction in twisting stress to the weld cable 403 relative to conventional weld cables in through-arm robotic applications. When the robot 101 moves the torch 102 connected to the cable assembly 400, twisting stress induced in the cable assembly 400 by the movement is transferred by the spring 404 along a length of the cable 403 instead of being concentrated in a portion of the cable 403 between the torch 102 and a bend in the cable 403.

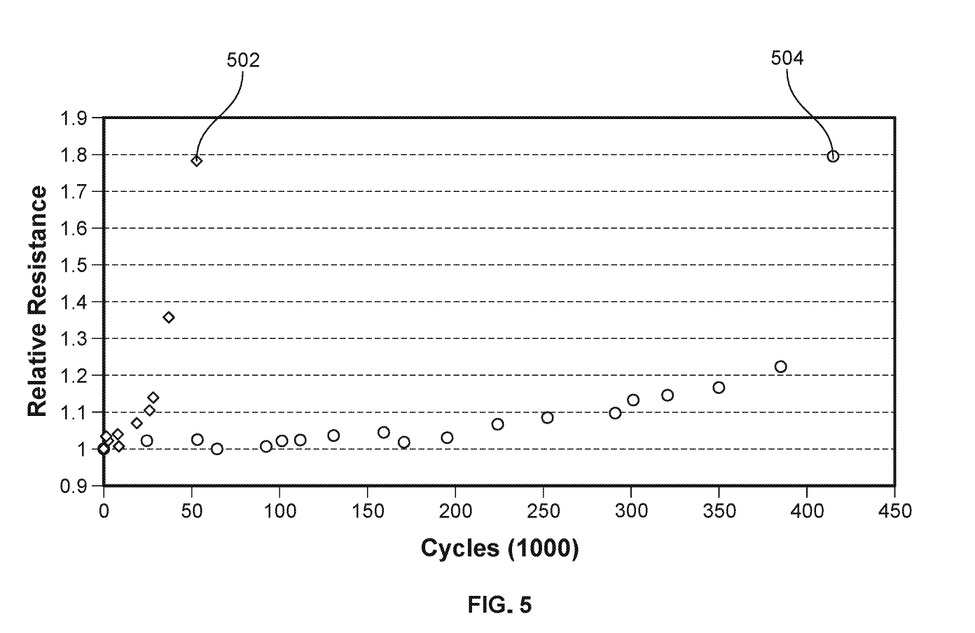

FIG. 5 is a graph illustrating a comparison of a twist life 502 of a conventional weld cable and a twist life 504 of the example weld cable assembly 400 of FIGS. 4A and 4B. The inner diameter of the spring 404 (0.860″) was slightly larger than the OD of the cable 403 (0.840″), the wire diameter of the spring 404 was 0.108″, and the spring pitch was 0.25″ in the cable assembly tested for the twist life 504. Both tested cables were tested in a through-arm robot, bent at 90 degrees, and twisted +/−220 degrees at 3 seconds per cycle. The electric resistance of the respective cables, in micro-ohms, were measured to demonstrate the decay of the cables. A weld cable can be regarded as failed when the resistance increases by about 20% (e.g., the relative resistance reaches 1.2). As illustrated in FIG. 5, the tested example cable assembly lasted approximately 7 times longer than the tested conventional cable.

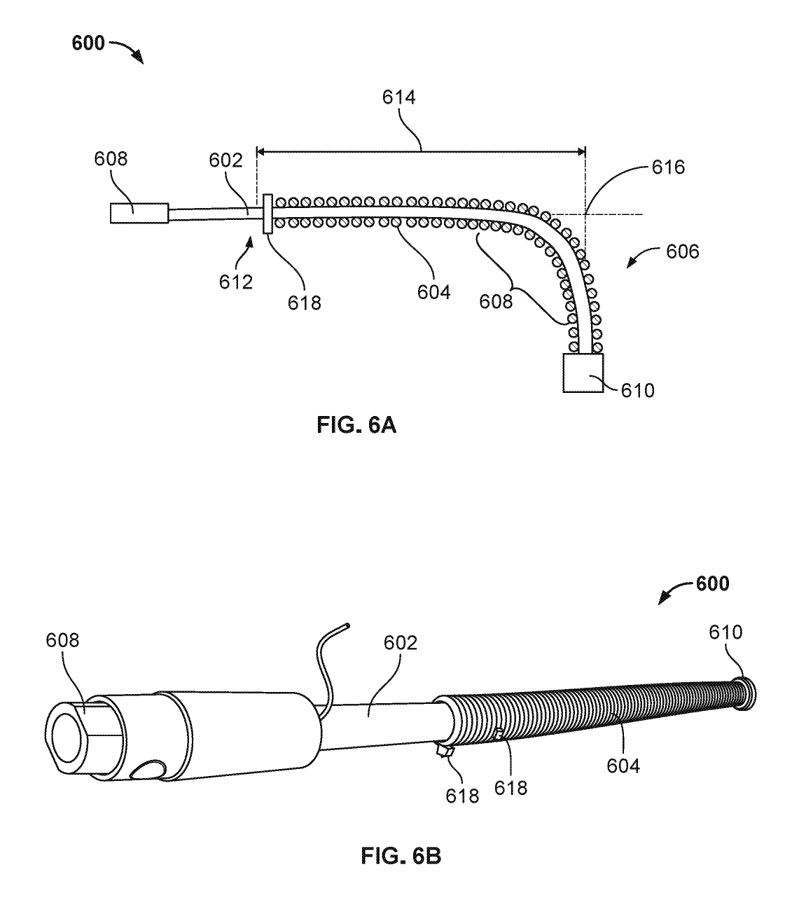

FIG. 6A is a block diagram of another example weld cable assembly 600 that may be used to implement the weld cable 104 of FIG. 1 with reduced twisting stress. FIG. 6B illustrates the example weld cable assembly of FIG. 6A. The example weld cable assembly 600 of FIGS. 6A and 6B includes a cable 602 and a spring 604. The cable 602 may be similar or identical to the weld cable 104 of FIGS. 1 and/or 2.

The spring 604 is rigidly attached to the cable 602 (e.g., a jacket of the cable 602, a connector attached to the cable 602, etc.) at a first end 606, and extends along the length of the cable 602 past a bending region 608 of the cable 602. The first end 606 of the cable 602, which may be the front end or the back end of the cable 602, may be attached to a connector 610, such as the cable adapter 300 of FIG. 3. The first end 606 of the cable 602 and/or the connector 610 may be configured to connect to either the weld torch 102 or to a wire feeder or power supply.

A second end 612 of the example spring 604 is rigidly fixed to the external jacket of the cable 602 at an intermediate location along the cable 602 instead of at the opposite end of the cable 602 (e.g., at a second connector). For example, a distance 614 from the second end 612 of the spring 604 to a pivot point 616 of the robot may be 8 inches or longer (e.g., 20 inches). The example spring 604 may be attached with a clamp 618, zip ties, and/or any other fastening or attachment device. In some other examples, the spring 604 is frictionally coupled to the cable 602 along the length of the spring 604 but is not rigidly secured to the cable 602 at the second end 612 of the spring 604. The frictional coupling between the spring 604 and the outer jacket of the cable 602 distributes twisting stress at least along the length of the cable 602 that is frictionally coupled to the spring 604.

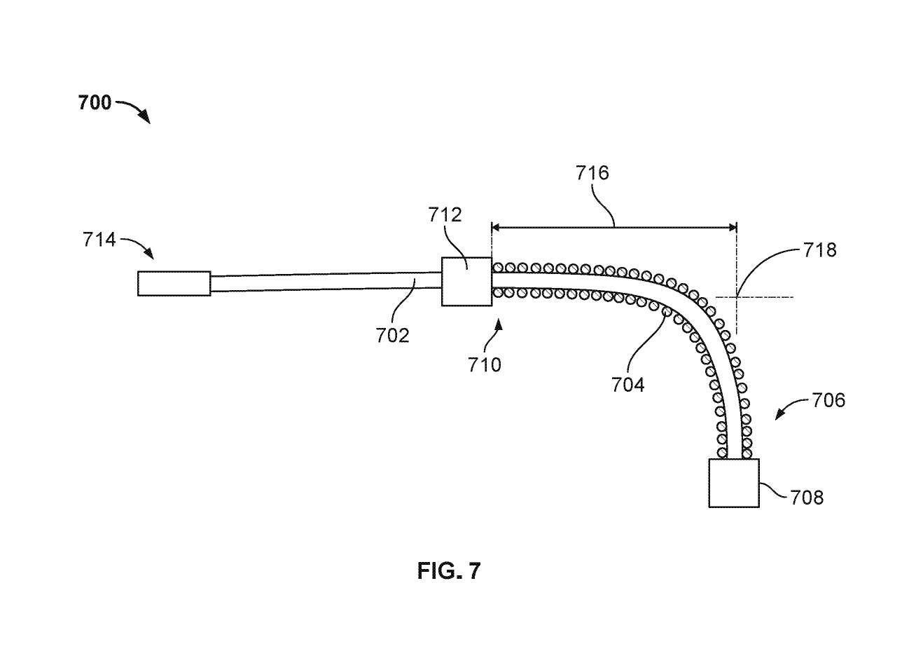

FIG. 7 is a block diagram of yet another example weld cable assembly 700 that may be used to implement the weld cable 104 of FIG. 1 with reduced twisting stress. The weld cable assembly 700 includes a cable 702 and a spring 704. The cable 702 may be similar or identical to the weld cable 104 of FIGS. 1 and/or 2.

The inner diameter of the example spring 704 is substantially larger than the outer diameter of the cable 702, such that the spring 704 is not frictionally coupled to the cable 702 (e.g., as in FIG. 6). That is, the spring 704 does not apply a substantial frictional force along the cable 702 in response to torque applied to the spring 704. For example, the difference between the inner diameter of the example spring 704 and the outer diameter of the cable 702 may be 0.030 inches or more.

A first end 706 of the spring 704 is rigidly attached to a first end of the cable 702, such as a connector 708 configured to connect the cable 702 to a weld torch, a wire feeder, or a power supply. A second end 710 of the spring 704 is rigidly attached to the cable 702 at an intermediate location along the cable 702 instead of at the opposite end 714 of the cable 602 (e.g., at a second connector). The example spring 704 may be attached at the first end 706 and/or at the intermediate location with a clamp 712, zip ties, and/or any other fastening or attachment device. For example, a distance 716 from the second end 710 of the spring 704 to a pivot point 718 of the robot may be 8 inches or longer (e.g., 20 inches).

In contrast to the example of FIG. 6, the spring 704 is rigidly coupled to the cable 702 at each end of the spring 704 but is not frictionally coupled to the cable 702 along a length of the spring 704. The example spring 704 transfers at least a portion of any twisting stress applied to the cable assembly 700 from a side at which the twisting stress is induced (e.g., at the connector 708) past the pivot point 718 (e.g., past the bending region of the cable) and applies the transferred stress to the cable 702 at the clamp 712. From the second end of the spring 704, the transferred twisting stress may further disperse along the cable 702.

As utilized herein, “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}.

In other words, “x, y and/or z” means “one or more of x, y and z”. As utilized herein, the term “exemplary” means serving as a non-limiting example, instance, or illustration. As utilized herein, the terms “e.g.,” and “for example” set off lists of one or more non-limiting examples, instances, or illustrations.

While the present method and/or system has been described with reference to certain implementations, it will be understood by those skilled in the art that various changes may be made and equivalents may be substituted without departing from the scope of the present disclosure. In addition, many modifications may be made to adapt a particular situation or material to the teachings of the present disclosure without departing from its scope. For example, systems, blocks, and/or other components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed is:

1. A welding-type cable assembly, comprising:
a cable configured to deliver welding-type current and an electrode wire to a welding-type torch, the cable configured to be coupled to the welding-type torch on a first end and coupled to at least one of a wire feeder or a welding-type power supply on a second end; and
a spring mechanically coupled to the cable, the spring having a higher resistance to torque than the cable, and the spring configured to transfer a portion of twisting induced at a first end of the cable past a bend portion of the cable.

2. The welding-type cable assembly as defined in claim 1, wherein a first end of the spring is rigidly fixed to an external jacket of the cable.

3. The welding-type cable assembly as defined in claim 2, wherein a second end of the spring is rigidly fixed to the external jacket of the cable.

4. The welding-type cable assembly as defined in claim 1, wherein a second end of the spring is rigidly fixed to an external jacket of the cable and a first end of the spring is configured to be rigidly fixed to the welding-type torch.

5. The welding-type cable assembly as defined in claim 2, further comprising a power connector attached to the cable, a second end of the spring being rigidly fixed to the power connector, the cable configured to be coupled to at least one of the wire feeder or the welding-type power supply via the power connector.

6. The welding-type cable assembly as defined in claim 2, wherein a second end of the spring is rigidly fixed to the cable at an intermediate location along a length of the cable.

7. The welding-type cable assembly as defined in claim 1, wherein the spring and the cable are frictionally coupled along a length of the spring, the spring configured to reduce twisting in the cable based on the frictional coupling.

8. The welding-type cable assembly as defined in claim 7, wherein the spring is configured to distribute twisting stress over a length of the cable that is frictionally coupled to the spring.

9. The welding-type cable assembly as defined in claim 1, wherein the welding-type cable assembly is configured to be positioned within a robotic arm of a robotic welding system.

10. The welding-type cable assembly as defined in claim 1, wherein an inner diameter of the spring is between 0.000 inches and 0.100 inches greater than an outer diameter of the cable or the outer diameter of the cable is between 0.000 inches and 0.010 inches greater than the inner diameter of the spring.

11. The welding-type cable assembly as defined in claim 1, wherein the spring is configured to be fixed to the welding-type torch and to a location along a length of the cable, and the spring is configured to not apply a substantial frictional force to the cable in response to torque applied to the spring.

12. A welding-type torch assembly for a robotic welding system, the welding-type torch assembly comprising:
a welding-type torch;
a cable configured to deliver welding-type current and an electrode wire to the welding-type torch, the cable coupled to the welding-type torch on a first end and configured to be coupled to at least one of a wire feeder or a welding-type power supply on a second end; and
a spring mechanically coupled to the cable, the spring having a higher resistance to torque than the cable, and the spring configured to transfer a portion of twisting induced at a first end of the cable past a bend portion of the cable.

13. The welding-type torch assembly as defined in claim 12, wherein the spring and the cable are frictionally coupled along a length of the spring, the spring configured to reduce concentration of twisting in the cable based on the frictional coupling.

14. The welding-type torch assembly as defined in claim 13, wherein the spring is configured to distribute twisting stress over a length of the cable that is frictionally coupled to the spring.

15. The welding-type torch assembly as defined in claim 12, further comprising a power connector attached to the cable, a second end of the spring being rigidly fixed to the power connector, the cable configured to be coupled to at least one of the wire feeder or the welding-type power supply via the power connector.

16. The welding-type torch assembly as defined in claim 12, wherein a first end of the spring is rigidly fixed to an external jacket of the cable.

17. The welding-type torch assembly as defined in claim 16, wherein a second end of the spring is rigidly fixed to the welding-type torch.

18. The robotic welding assembly as defined in claim 12, wherein the spring is fixed to the welding-type torch and to a location along a length of the cable, and the spring does not apply a substantial frictional force to the cable in response to torque applied to the spring.

19. A robotic welding assembly for a robotic welding system, the robotic welding assembly comprising:
a welding-type torch;
a cable configured to deliver welding-type current and an electrode wire to the welding-type torch, the cable coupled to the welding-type torch on a first end and configured to be coupled to at least one of a wire feeder or a welding-type power supply on a second end; and
a spring mechanically coupled to the cable, the spring having a higher resistance to torque than the cable; and
a robotic arm configured to manipulate the welding-type torch, the robotic arm configured to bend a portion of the cable when manipulating the welding-type torch, the spring configured to transfer at least a portion of a twisting stress on a first portion of the cable, resulting from manipulation of the welding-type torch by the robotic arm, to a second portion of the cable across a bend portion of the cable from the first portion of the cable.

20. The robotic welding assembly as defined in claim 19, wherein the cable is disposed within the robotic arm in a through-arm configuration.
